(19) United States
(12) Patent Application Publication
(10) Pub. No.: US 2020/0304368 A1
(43) Pub. Date: Sep. 24, 2020

(54) ACCESSING PROCESSING DEVICES OF A NETWORK DEVICE

(71) Applicant: Arista Networks, Inc., Santa Clara, CA (US)

(72) Inventors: Aparna Karanjkar, Cupertino, CA (US); Ashwin Deepak Swaminathan, Santa Clara, CA (US); Vidya Kirupanidhi, Santa Clara, CA (US); Simon Francis Capper, San Jose, CA (US)

(21) Appl. No.: 16/359,920

(22) Filed: Mar. 20, 2019

(51) Int. Cl. H04L 12/24; H04L 12/773

(52) U.S. Cl. CPC H04L 41/0806; H04L 41/0893; H04L 41/046; H04L 45/60

(57) ABSTRACT

In some implementations, a method is provided. The method includes receiving, by an agent of a first container of a network device from a second container of the network device, a request for a forwarding engine of the network device to perform an operation. The first container and the second container are located on a control plane of the network device. The first container comprises a set of drivers to support multiple types of forwarding engines. The first container further comprises an operating system. The method also includes providing the request to the operating system. The operating system uses a first driver of the set of drivers to communicate with the forwarding engine. The method further includes performing the operation requested by the second container. The method further includes providing a result of the operation to the second container in response to determining that the result should be provided to the second container.

### BACKGROUND

A network device may be a device (e.g., a computing device, an electronic device etc.) capable of communicating data with other devices through a wired or wireless connection or set of connections. For example, a network device may receive data from a first device (e.g., a computing device, a switch, a router, etc.) and may forward the data to a second device (e.g., a computing device, a switch, a router, etc.). A network device may include various types of hardware that may be used to transmit and/or receive data. For example, a network device may include line cards and each line card may include one or more processing devices (e.g., application specific integrated circuits, field programmable gate arrays, processors, central processing units, forwarding engines, etc.) to transmit and/or receive data (e.g., network packets).

### SUMMARY

In some implementations, a method is provided. The method includes receiving, by an agent of a first container of a network device from a second container of the network device, a request for a forwarding engine of the network device to perform an operation. The first container and the second container are located on a control plane of the network device. The first container comprises a set of drivers to support multiple types of forwarding engines. The first container further comprises an operating system. The method also includes providing the request to the operating system. The operating system uses a first driver of the set of drivers to communicate with the forwarding engine. The method further includes performing the operation requested by the second container. The method further includes providing a result of the operation to the second container in response to determining that the result should be provided to the second container.

In some implementations, a network device is provided. The network device includes a memory configured to store a first container and a second container. The network device also includes a processing device coupled to the memory. The processing device may receive a request for a forwarding engine of the network device to perform an operation. The first container and the second container are located on a control plane of the network device. The first container comprises a set of drivers to support multiple types of forwarding engines. The first container further comprises an operating system. The processing device may also provide the request to the operating system. The operating system uses a first driver of the set of drivers to communicate with the forwarding engine. The processing device may further perform the operation requested by the second container. The processing device may further provide a result of the operation to the second container in response to determining that the result should be provided to the second container.

In some implementations, a non-transitory machine-readable medium having executable instructions to cause one or more processing devices to perform a method is provided. The method includes receiving, by an agent of a first container of a network device from a second container of the network device, a request for a forwarding engine of the network device to perform an operation. The first container and the second container are located on a control plane of the network device. The first container comprises a set of drivers to support multiple types of forwarding engines. The first container further comprises an operating system. The method also includes providing the request to the operating system. The operating system uses a first driver of the set of drivers to communicate with the forwarding engine. The method further includes performing the operation requested by the second container. The method further includes providing a result of the operation to the second container in response to determining that the result should be provided to the second container.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example of a network device, in accordance with some embodiments.

FIG. 2 is a block diagram illustrating an example of a network device, in accordance with some embodiments.

FIG. 3 is a block diagram illustrating an example of a network device, in accordance with some embodiments.

FIG. 4A is a flow diagram of a method of accessing processing devices in a data plane of network device, in accordance with some embodiments.

FIG. 4B is a flow diagram of a method of accessing one or more network stacks, in accordance with some embodiments.

FIG. 5 shows an example a computing device, in accordance with some embodiments.

FIG. 6 is a block diagram of one embodiment of an exemplary network device, in accordance with some embodiments.

### DETAILED DESCRIPTION

As discussed above, a network device may be a device (e.g., a computing device, an electronic device, etc.) that may communicate data with other devices (e.g., may receive data from a first device and may forward the data to a second device. A network device may include a control plane and a data plane. A control plane may process control information and write configuration data used to manage and/or configure the data plane. The control plane may also perform control management updates and/or respond with control message responses (e.g., routing decisions, protocol updates, traffic resolutions, etc.). The data plane receives, processes, and forwards network data based on the configuration data, as discussed in more detail below.

Specific drivers or libraries may be used to access, communicate with, and/or manage the processing devices used in a data plane. Thus, a user (e.g., a network administrator) should generally have knowledge of the types of processing devices (e.g., the type of ASICs, FPGAs, forwarding engines, etc.) that are used in the data plane. Tracking and managing the different libraries/drivers that are used may be a difficult, cumbersome, and/or inefficient process for the user. The embodiments, implementations, and examples, described herein allow a network device to access, communicate with, manage, and/or perform operations using processing devices more quickly and/or efficiently. The network device includes a primary or host operating system. The primary or host operating system may not include the drivers and/or libraries that may be used to access, communicate with, manage, and/or perform operations using the processing devices in the data plane. The network device also includes a second standalone or complete operating system. Because the second operating system is a standalone or complete operating system, the second operating system may include multiple types of drivers and/or libraries that may be used to access, communicate with, manage, and/or perform operations using the processing devices in the data plane. The network device may use the drivers and/or libraries of the second operating system to access, communicate with, manage, and/or perform operations using processing devices.

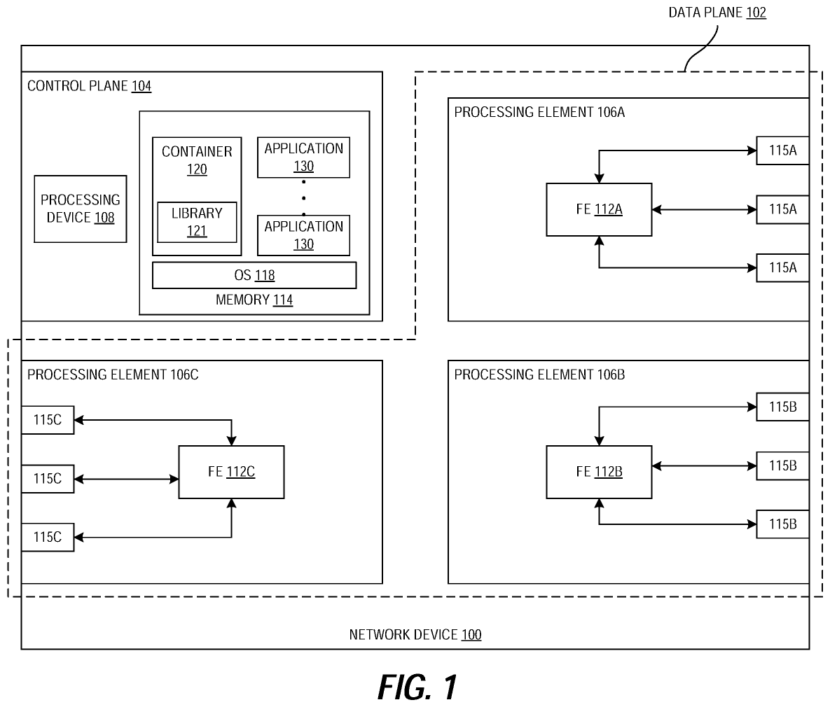

FIG. 1 is a block diagram of one embodiment of a network device 100 that includes a control plane 104 and a data plane 102. Network device 100 may be any type of device that can communicate network data with another device (e.g., a personal computer, laptop, server, mobile device, a phone, a smartphone, a personal gaming device, another network device, switch, router, hub, bridge, gateway, etc.). For example the network device 100 may receive data from a first device and may forward the data to another device, and vice versa. In one embodiment, network device 100 may be a device that hosts one or more containers and/or virtual machines, as discussed below. In other embodiments, network device 100 may be a virtual machine or a container.

In one embodiment, the data plane 102 receives, processes, and forwards network data using various configuration data (e.g., packet forwarding (routing, switching, or another type of packet forwarding), security, quality of service (QoS), and other network traffic processing information). For example, for each received packet of the network traffic, the data plane 102 determines a destination address of that packet, looks up the requisite information for that destination in one or more memories of data plane 102, and forwards the packet out the proper outgoing interface. The data plane 102 includes multiple data processing elements 106A through 106C that can each receive, process, and/or forward network traffic. A data processing element may also be referred to as a line card of network device 100. In one embodiment, each data processing element 106A through 106C includes a forwarding engine (FE) 112A through 112C and ports 115A through 112C, respectively. FEs 112A through 112C may be processing devices that may receive packets on a port and/or transmit the packets to one or more other ports (e.g., forward the packets to one or more other ports). Examples of FEs 112A through 112C include, but are not limited to, application specific integrated circuits (ASICs), field programmable gate arrays (FPGA), processors, multi-core processors, central processing units (CPUs), circuitry, and/or other types of processing logic.

In one embodiment, control plane 104 includes processing device 108 (e.g., a central processing unit (CPU), a processor, a multi-core processor, a processing core, etc.) and memory 114. As discussed herein, processing device 108 may be referred to as a control plane processor of network device 100. Control plane 104 is used to process control information for control plane 104 and/or data plane 102, and write configuration data for forwarding engines 112A-C in the data processing elements 106A through 106C. The information processed by control plane 104 includes, for example, control plane data corresponding to a plurality of different classes of control plane traffic, such as routing protocol messages, routing table messages, routing decisions messages, route update messages, unresolved traffic messages, L2 protocol messages, link aggregation control protocol messages, link layer state updates messages (e.g., spanning tree messages), link state update messages (e.g., link aggregation control protocol messages for a link aggregation group, bidirectional forwarding detection messages, etc.), exception packets that cannot be dealt with in hardware (e.g., router alerts, transmission time interval messages, maximum transmission size exceeded messages, etc.), program messages (e.g., packets from a controller instructing the programming of a network device), messages for routing table misses, time control messages (e.g., precision time protocol messages), messages for packets marked as being of interest for snooping (e.g., access control list logging and port mirroring messages), messages used to collect traffic diagnostics, address resolution messages (ARP) requests and replies, neighbor solicitation requests and replies, general communication to the control plane of the networking device, etc. Control plane 104 processes the control plane network data to perform control management updates and/or respond with control message responses (e.g., routing decisions, protocol updates, traffic resolutions, etc.).

In one embodiment, memory 114 includes operating system (OS) 118 that may be executed by processing device 108. For example, OS 118 may include various computing processes, computing services, threads, etc., that may be executed by processing device 108. Memory 114 also includes container 120. Container 120 may be an isolated set of resources allocated to executing an application, software, service, process, and/or operating system independent from other applications, software, and/or processes. Container 120 may share the kernel, libraries, and binaries of OS 118 (which may be referred to as a host OS) with other containers that are on network device 100. A container engine (not illustrated in the figures) may allow different containers to share the host OS (e.g., the OS kernel, binaries, libraries, etc.). For example, the container engine may multiplex the binaries and/or libraries of the host OS between multiple containers. The container engine may also facilitate interactions between the container and the resources of the computing device. The container engine may also be used to create, remove, and manage containers. In one embodiment, the container engine may be component of OS 118. In another embodiment, container engine may run on top of OS 118, or may run directly on hardware without the use of OS 118. OS 118 may not include the drivers and/or libraries that may be used to access, communicate with, manage, and/or perform operations using the processing devices in the data plane.

In one embodiment, applications 130 execute various aspects of the functionality of control plane 104. For example, one application 130 may be used for quality of service, access control lists management (or other types of security), policy service, etc. Other examples of operations that may be performed by application 130 may include a fan control, a light emitting diode control, a temperature sensing, database services, management service(s), operations to support networking protocols (e.g., spanning tree protocol (STP), routing protocols (e.g., such as routing information protocol (RIP), border gateway protocol (BGP), open shortest path first (OSPF), intermediate system-intermediate system (IS-IS), interior gateway routing protocol (IGRP), enhanced IGRP (EIGRP), protocol independent multicast (PIM), distance vector multicast routing protocol (DVMRP), and any/or other type or unicast or multicast routing protocol), Multiprotocol Label Switching (MPLS), and/or other types of networking protocols), network flow management applications (e.g., openflow, directflow), process manager, and/or other types of functionality of the network device 100.

In one embodiment, for each received unit of network data (e.g., a packet), the data plane 102 determines a destination address for the network data, looks up the requisite information for that destination in one or more tables stored in the data plane, and forwards the data out the proper outgoing interface, for example, one of the data processing elements 106A-C. In one embodiment, each data processing elements 106A-C includes one or more forwarding engines (FE(s)) 112A-C and ports 115A-C, respectively. Each forwarding engine 112A-C forwards data for network device 100, such as performing routing, switching, or other types of network forwarding or processing.

In some embodiments, users may want the software of control plane 104 to be independent of the hardware what is used in network device 100 (e.g., may want the software of control plane 104 to be hardware agnostic). For example, the software of control plane 104 (e.g., OS 118, applications 130, etc.) should be able to perform various functions, operations, actions, etc., regardless of the hardware that is used in data plane 102. Different line cards with different FEs may be used in the data plane and users may want the software of control plane 104 to be able to perform the same functions, operations, actions, etc., using the different line cards and/or the different FEs.

Control plane 104 (e.g., software of control plane 104 such as applications 130) may communicate with the FEs 112A through 112C to perform the various functions, operations, actions, etc. For example, an application 130 may set the internet protocol (IP) address of one or more ports 115A through 115C. In another example, application 130 may request the value of a configuration setting or parameter of the data plane (e.g., may request the IP address of a network interface). As illustrated in FIG. 1, container 120 includes a library 121. The library 121 may be used by to access FEs 112A through 112C. For example, the library 121 may include application programming interfaces (APIs), function calls, routings, remote procedure calls (RPCs), etc., that may be used by application 130 and/or control plane 104 to access and/or communicate with one or more of the FEs 112A through 112C. Library 121 may be provided by a vendor or manufacturer of the hardware (e.g., FE 112A, a line card, etc.) used in data plane 102

Because specific drivers or libraries are used to access, communicate with, and/or manage FEs 112A through 112C, a user should generally have knowledge of the type of FEs that are used in data plane 102 (e.g., the design, architecture, make, model, etc., of the FEs). If new FEs are added to network device 100, new libraries or drivers should be added to container 120 to allow control plane 104 to access, communicate with, and/or manage FEs 112A through 112C. This may be a cumbersome and time consuming process for a user (e.g., a network administrator). In addition, it may be difficult for the user to determine all of the different types of FEs that may be used in data plane 102 and load the libraries/drivers for those different types of FEs, into the container 120.

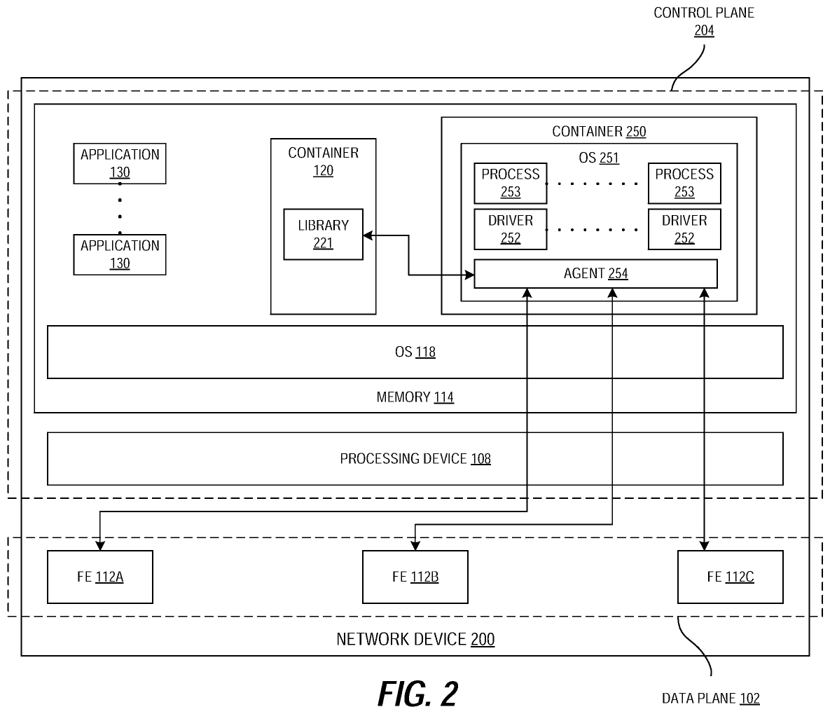

FIG. 2 is a block diagram illustrating an example network device 200, in accordance with some embodiments. Network device 200 includes control plane 204 and data plane 102. As discussed above, data plane 102 receives, processes, and forwards network data using various configuration data. Data plane 102 includes FEs 112A through 112C. FEs 112A through 112C may be processing devices such as ASICs, FPGAs, CPUs, etc., that may receive, process, and/or forward network data between ports of the network device 200. FEs 112A through 112C may be part of data processing elements (e.g., line cards) as discussed above.

Control plane 204 includes a processing device 108, Control plane 204 is used to process control information for the control plane 204 and/or data plane 102, and write configuration data for forwarding engines 112A through 112C. For example, control plane 204 processes the control plane network data to perform control management updates and/or respond with control message responses (e.g., routing decisions, protocol updates, traffic resolutions, etc.). Control plane 204 includes a memory 114. Examples of memory 114 may include non-volatile memory (e.g., memory which retains data even if the memory loses power), such as a flash memory, a hard disk, a disk drive, a flash chip, and/or may include volatile memory (e.g., a memory that does not retain data if the memory loses power), such as a random access memory (RAM). The memory includes applications 130, container 120, and container 250. As discussed above, applications 130 may execute various aspects of the functionality of control plane 204. For example, an application 130 may process address resolution protocol (ARP) messages or packets (e.g., may respond to ARP resolution requests). In some embodiments, one or more of applications 130 may execute within one or more additional containers (e.g., other containers in addition to container 120 and container 250).

Container 120 includes library 221. Library 221 may provide an interface and/or functions to allow applications 130 to communicate with and/or access FEs 112A through 112C. For example, first application 130 may use library 221 to communicate with FE 112A, to request FE 112A to perform an operation or action, etc. Library 221 may provide an API, a set of functions, a set of procedures, etc., as discussed above. Library 221 may receive a request from an application 130 (or some other module, software, application, etc. of control plane 204) to have one or more of FEs 112A through 112C perform an operation and/or access/communicate with one or more of FEs 112A through 112C. For example, library 221 may receive a request to update a routing table used by one or more of FEs 112A through 112C. As discussed above, library 121 (of FIG. 1) included a driver that would be used to access one or more of FEs 112A through 112C. The driver may be specific to a type of FE. Thus, in order to allow network device 200 to support different types of FEs (e.g., different makes and models of FEs), a user would either develop drivers and/or libraries for different types of FEs, or obtain drivers and/or libraries from different vendors. This is a cumbersome process and may also result in more effort on the part of the user to determine all of the different types of FEs that may be used, and to obtain drivers/libraries for those different types of FEs.

In one embodiment, library 221 may not include drivers or libraries for different types of FEs. Instead, when library 221 receives a request to access/communicate with an FE or to have an FE perform an operation, library 221 may redirect, forward, transmit, provide, etc., that request to container 250. As illustrated in FIG. 2, container 250 includes OS 251. In one embodiment, OS 251 may be a complete or standalone operating system that is capable of executing on network device 200 and/or another computing/network device. For example, OS 251 may include various services, processes, modules, etc., that may be able to perform various control plane functions, network forwarding functions, and/or may be able to communicate with various different types of hardware, if OS 251 were to be used as the primary operating system for a computing/network device. OS 251 includes drivers 252. Driver 252 may be an application or program that operates or controls a device, such as a hardware device. Driver 252 may also allow other devices, other processes, services, modules, etc., to communicate with the device.

In one embodiment, because OS 251 is a complete/standalone operating system, OS 251 may inherently include drivers 252 to allow OS 251 (and other applications, processes, services, etc.) to control, operate, and/or communicate with various different types of devices or hardware. In one embodiment, drivers 252 may allow OS 251 to communicate with various types of forwarding engines (e.g., various types of ASICs, FPGAs, CPUs, processing devices, etc.). For example, different types of forwarding engines may be forwarding engines that are manufactured or sold by different vendors (e.g., different companies). In another example, different types of forwarding engines may be different models or different lines of forwarding engines from the same manufacturer or vendor. Thus, drivers 252 may allow OS 251 (and other applications, processes, services, etc.) to control, operate, and/or communicate with forwarding engines that are from various different vendors and/or with various different models of forwarding engines from the same vendor. This allows network device 200 to have simple function calls, APIs, procedures, etc., within library 221, rather than including a driver for a particular type of FE. Because OS 251 may inherently include various drivers 252, the library 221 is able to rely on OS 251 to provide appropriate drivers or libraries that may be used to communicate/access FEs 112A through 112C.

In one embodiment, agent 254 may determine the type of FEs 112A through 112C. For example, agent 254 may determine the make, model, or other identifying information (e.g., a serial number, a part number, etc.) for the FEs 112A through 112C. Agent 254 may identify the appropriate driver 252 to use when accessing/communicating with FEs 112A through 112C, based on the type of FEs 112A through 112C. For example, agent 254 may identify driver 252 that is used to access or communicate with a specific make and model number of FEs. In one embodiment, agent 254 may determine the type of FEs 112A through 112C by accessing configuration data, settings, or parameters stored in control plane 204. For example, agent 254 may access a configuration file that may indicate the type of FEs 112A through 112C. In another embodiment agent 254 may query FEs 112A through 112C to determine their type. For example, agent 254 may transmit a message to FEs 112A through 112C to request information (e.g., serial number, model number, etc.) that may be used to determine the type of FEs 112A through 112C.

OS 251 also includes an agent 254. Agent 254 may be a process, program, service, application, etc., that is executing within container 250. Thus, agent 254 may be referred to as a process or an operating system process. Although agent 254 is illustrated as part of OS 251, the agent may be separate from OS 251 in other embodiments. For example, agent 254 may be a separate application executing within container 250. As discussed above, library 221 may provide a request to access/communicate with one or more FEs 112A through 112C or a request to have one or more FEs 112A through 112C perform an operation, to container 250. This request may be received by OS 251 and/or agent 254. For example, library 221 may include an API, function, etc., that transmit the request to OS 251 and/or agent 254.

In one embodiment, agent 254 may translate the request received from 221 into a format that may be used or recognized by OS 251. For example, agent 254 may change the order of parameters in a function call, convert a parameter to a different format (e.g., convert timestamp formats, convert an IPv4 address to an IPv6 address, etc.), etc. The format may be based on one or more processes 253 of OS 251 that may be used to access/communicate with FEs 112A through 112C or to perform operations using FE 112A through 112C. For example, a process 253 (e.g., an operating system process, a service, another agent, etc.) may be used to create a virtual local area network (VLAN) using FE 112A. Process 253 may expect different types of data in different formats than other processes in OS 251. The agent 254 may determine that the request is for process 253 and may translate the request (e.g., translate a command, a parameter, etc.) to a format recognized or used by process 253. Agent 254 may then provide the request (e.g., the translated request) to the process 253. In another embodiment, library 221 may translate the request prior to providing the request to agent 254.

In one embodiment, process 253 may perform an operation on one or more FEs 112A through 112C or using one or more FEs 112A through 112C. For example, process 253 may instruct FE 112A to add an entry in a route table (e.g., a routing table, a forwarding table, etc.) used by FE 112A. In another example, process 253 may instruct FE 112B to change an IP address of an interface (e.g., a network interface, a port, etc.) that is managed by FE 112B. The process 253 may use a driver 252 for FEs 112A through 112C to communicate, access, or perform operations on/using FEs 112A through 112C. Process 253 may perform various types of operations on/using FEs 112A through 112C. In one embodiment, process 253 may use FE 112A to set a configuration setting or a parameter of the data plane 102. For example, process 253 may set the IP address of a network interface in the data plane 102. In another example, process 253 may use FE 112A to get the value a configuration setting or a parameter of the data plane 102. For example, process 253 may request the IP address of a network interface in the data plane 102, from FE 112A. Examples of operations that may be performed on and/or using the FEs 112A through 112C include, but are not limited to, adding a VLAN, deleting a VLAN, setting an IP address for an interface, adding an IP route, deleting an IP rout, configuration the IP address of a port, adding an ARP entry, deleting an ARP entry, setting quality of service parameters, getting an IP rout, getting a VLAN (e.g., a VLAN ID), getting a current state of a link or port, getting a MAC address of a port, and getting statistics associated with a port (e.g., number of packets transmitted/received, number of dropped packets, etc.).

In one embodiment, agent 254 may determine whether a result of the operation should be provided to container 120 and/or library 221. For example, the request received from library 221 may indicate whether library 221 is expecting a result for the operation. If agent 254 determines a result of the operation should be provided to container 120 and/or library 221, agent 254 may transmit a message indicating the result of the operation to container 120 and/or library 221. For example, the operation requested by library 221 may be a request to determine the IP address for a port. Agent 254 may determine that the IP address for the port should be provided to library 221 and may transmit a message with the IP address for the port to library 221. In another example, the operation requested by library 221 may be a request for FE 112A to set a configuration parameter to a particular value (e.g., set an IP address of a port to a particular IP address). Agent 254 may determine that library 221 is waiting for a confirmation that the configuration parameter was set to the particular value and may transmit data (e.g., a number, an alphanumeric value, etc.) indicating whether the configuration parameter was set to the particular value.

In one embodiment, agent 254 may determine whether one or more of FEs 112A through 112C has detected an event that may have occurred in the data plane 102. For example, agent 254 may determine FE 112A has detected that a port (e.g., a link or a network interface) that is managed by FE 112A, is no longer operational (e.g., a link or interface has gone down). Agent 254 may determine one of more of FEs 112A through 112C has detected an event in various ways. For example, agent 254 may receive a message from one or more of FEs 112A through 112C indicating that an event has occurred. The message may also provide additional information about the event. For example, the message may indicate what event has occurred and may indicate other information associated with the event. In another example, agent 254 may detect an interrupt (e.g., a signal, a hardware interrupt, a software interrupt, etc.) generated by one or more of FEs 112A through 112C. The interrupt may indicate that an event has occurred and may also provide additional information about the event.

In one embodiment, the processes 253 of the OS 251 may perform functions, actions, and/or operations of control plane 204. For example, process 253 may respond to ARP requests. In another example, process 253 may create VLANs or virtual extensible LANS (VXLANs). The OS 251 may perform these functions, actions, and/or operations in conjunction with OS 118. For example, OS 118 may allow OS 251 to perform certain control plane functions while OS 118 performs other control plane functions. Because OS 251 is a standalone or complete operating system, OS 251 may provide functions, features, operations, etc., that may be used and/or leveraged by network device 200. For example, rather than implementing an ARP process or an application 130 to process ARP messages, OS 118 may use the a process 253 (e.g., an ARP process of OS 251) to process the ARP messages.

As discussed above, control plane 104 (e.g., software of control plane 104 such as applications 130) may communicate with the FEs 112A through 112C to perform the various functions, operations, actions, etc. Users may want the software of control plane 104 to be independent of the hardware what is used in network device 100 (e.g., may want the software of control plane 104 to be hardware agnostic). However, because specific drivers or libraries are used to access, communicate with, and/or manage FEs 112A through 112C, the task of managing, installing, and configuring the libraries or drivers may be time consuming and/or difficult for the user. If new types of FEs are added to network device 100, new libraries or drivers should be added to container 120 to allow control plane 104 to access, communicate with, and/or manage FEs 112A through 112C. This may be a cumbersome and time consuming process for a user, such as a network administrator. In addition, it may be difficult for the user to determine all of the different types of FEs that may be used in data plane 102 and load the libraries/drivers for those different types of FEs, into container 120.

Because OS 251 is a standalone or complete operation system, OS 251 may inherently include multiple drivers 252 that may be used to access, communicate with, manage, and/or perform operations using many different types of processing devices in the data plane. This allows network device 200 to use OS 251 to manage the drivers and/or libraries that may be used to access FEs 112A through 112C. This may simplify the task of managing all of the different types of drivers and/or libraries, which was previously performed by the user. In addition, this allows the network device 200 to have simple function calls, APIs, procedures, etc., within library 221, rather than including a driver for a particular type of FE. Furthermore, as OS 251 is updated (e.g., new patches or releases of OS 251 are provided), OS 251 may obtain new drivers and/or libraries that may be used for new devices (e.g., new types of FEs). Many OSes have an update process (e.g., automatic updates) that the user may execute. This may allow network device 200 to more easily manage and/or support new types of FEs by updating OS 251.

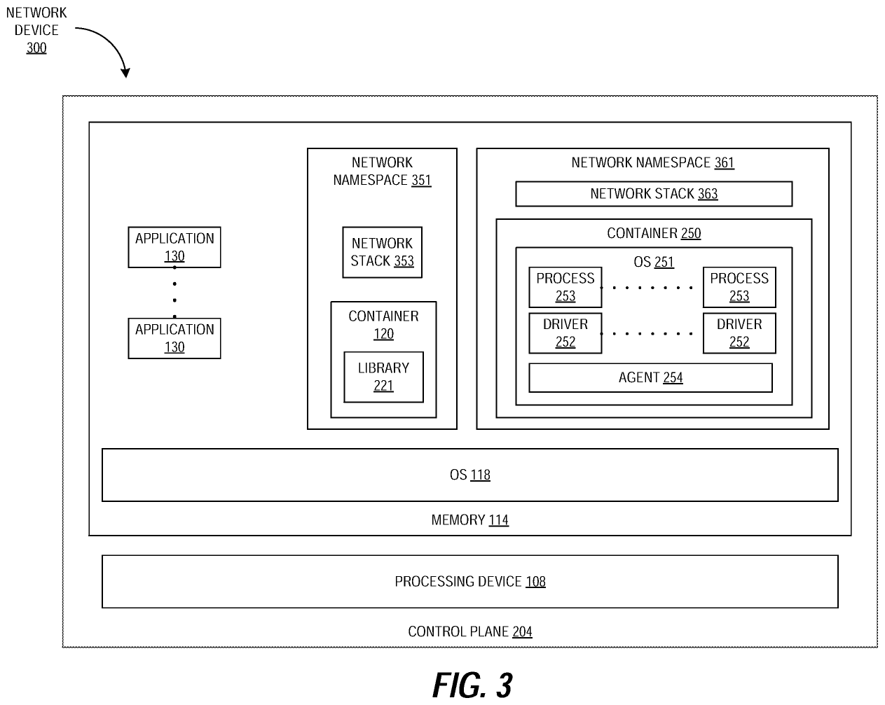

FIG. 3 is a block diagram illustrating an example network device 200, in accordance with some embodiments. Network device 300 includes a control plane 204 and a data plane (not illustrated in FIG. 3). As discussed above, a data plane (e.g., data plane 102 illustrated in FIGS. 1 and 2) receives, processes, and forwards network data using various configuration data. A data plane may include one or more FEs (e.g., FEs 112A through 112C illustrated in FIGS. 1 and 2). Control plane 204 includes a processing device 108, Control plane 204 is used to process control information for the control plane 204 and/or data plane 102, and write configuration data for forwarding engines 112A through 112C. For example, control plane 204 processes the control plane network data to perform control management updates and/or respond with control message responses (e.g., routing decisions, protocol updates, traffic resolutions, etc.). Control plane 204 includes a memory 114 (e.g., one or more of flash memory, RAM, etc.). The memory includes applications 130, container 120, and container 250. As discussed above, applications 130 may execute various aspects of the functionality of control plane 204.

As illustrated in FIG. 3, container 120 is located within network namespace 351 and container 250 is located within network namespace 361. Generally, a namespace may be a partition, division, grouping, etc., of resources of an operating system (e.g., kernel resource), such as OS 118. This allows different processes, services, applications, programs, etc., that are operating on a device to have access to different sets of resources. There may be multiple types of namespaces (e.g., a mount namespace, a process ID (PID) namespace, a user ID namespace, etc.). One type of namespace may be a network namespace (e.g., network namespace 351 and network namespace 361). A network namespace may include its own network stack. For example, network namespace 351 includes network stack 353 and network namespace 361 includes network stack 363. Each of network stack 353 and network stack 363 may include a set of IP addresses, routing tables, socket listings, firewall, and various other network related resources.

In one embodiment, network namespace 351 may be separate from network namespace 361. Thus, network stack 352 is separate from network 363. This may allow applications, programs, processes, services, OSes, etc., within container 120 to modify network stack 353 (e.g., to add a new route in a routing table) without affecting network stack 363. This may allow applications, programs, processes, services, OSes, etc., within container 250 to modify network stack 363 (e.g., to add a new route in a routing table) without affecting network stack 353.

As discussed above, although the control plane includes OS 118 (as the primary OS), the container 250 also includes OS 251. OS 251 may be a complete or standalone OS. Because OS 251 is a complete or standalone OS, OS 251 includes drivers 252 and processes 253 (e.g., operating system processes). In addition, because OS 251 is a complete or standalone OS, processes 253 may expect to be able to modify a network stack when executing or operating. For example, a process 253 may modify an IP route table, an ARP table, etc., because the OS 251 generally expects to have access to the network stack when OS 251 operates as a primary OS. However, because OS 118 may be the primary OS for network device 300, processes 253 of OS 251 should not modify the network stack (e.g., network stack 353) used by OS 118. By including container 250 in a separate network namespace 361, processes 253 and/or OS 251 may continue to operate as normal and modify network stack 363. Because network stack 363 is part of network namespace 361, processes 253 and/or OS 251 may modify network stack 363 without affecting other network stacks used by the network device 300. For example, process 253 and/or OS 251 may modify network stack 363 without affecting network stack 353, which may be the primary network stack used to configure and/or manage network resources of network device 300. In some embodiments, network stack 353 and/or network stack 363 may be located within one or more containers. For example, network stack 353 may be located within container 120 and network stack 363 may be located within container 250.

In one embodiment, agent 254 may be allowed to make certain modifications to network stack 353. For example, agent 254 may be allowed to create an interface, such as kernel interface, in network stack 353. The interface may correspond with a network interface (e.g., a network interface, a port, etc.). Agent 254 may communicate with container 120 and/or library 221 to determine what type of operations and/or modifications to the network stack 353 the agent is allowed to perform. For example, agent 254 may request permission and making a modification to network stack 353 and library 221 may grant agent 254 to make the modification. In another example, agent 254 may receive a list of operations/modifications from library 221. In another embodiment, agent 254 may also be allowed to transmit and/or receive data via the data plane. For example, agent 254 may be allowed to receive a packet via the data plane and/or network stack 353 and may forward the data to the container 120 or the OS 118.

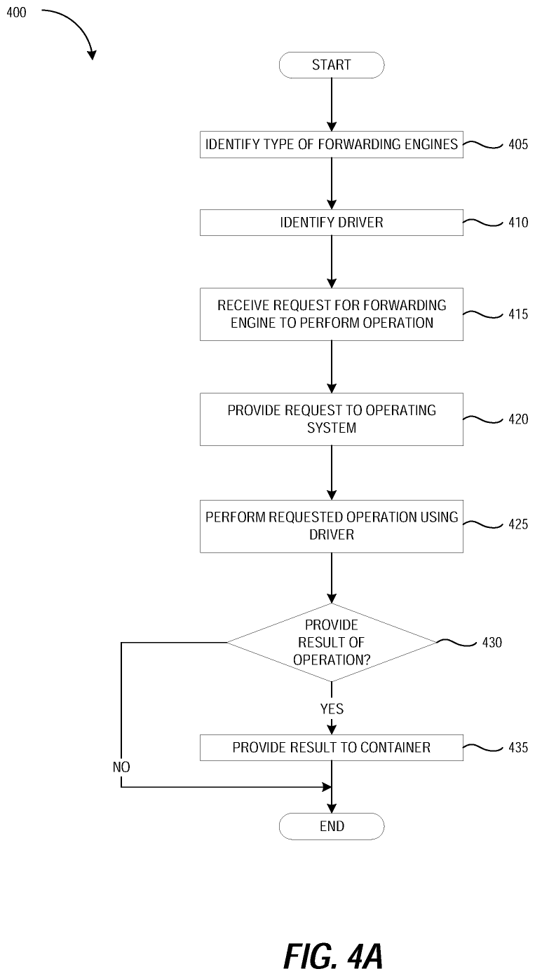

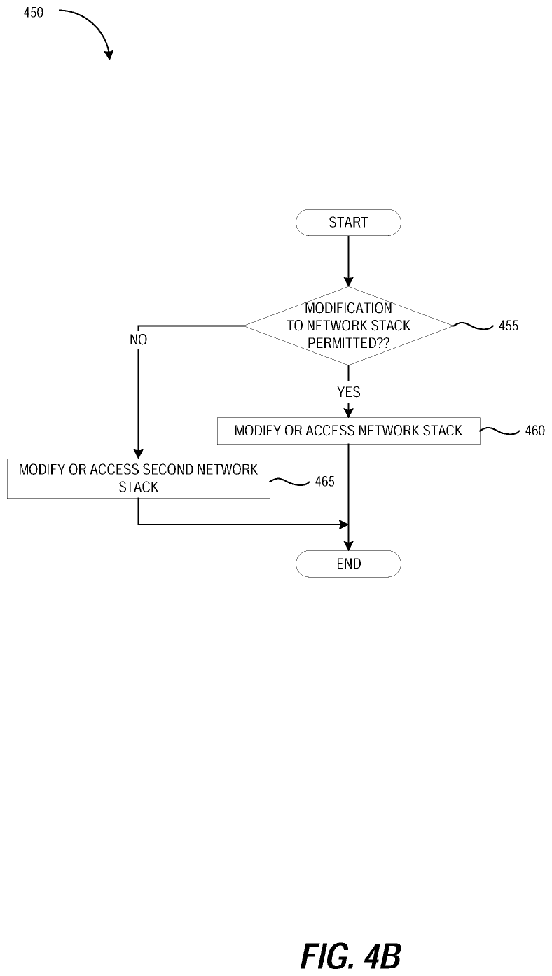

FIG. 4A is a flow diagram of a method 400 of accessing processing devices, such as forwarding engines, in a data plane of network device, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, method 400 may be performed by a network device (e.g., network device 200 and 300 illustrated in FIGS. 2 and 3), an agent (e.g., agent 254 illustrated in FIGS. 2 and 3), and/or a processing device (e.g., processing device 108 illustrated in FIGS. 2 and 3). It should be appreciated that the actions of method 400 in FIG. 4A can be performed in differing orders, groupings, or subsets than shown in FIG. 4A, for various purposes or user preferences.

Method 400 begins at block 405 where the agent identifies the type of the forwarding engines (e.g., processing devices, ASICs, etc.) used in a data plane of the network device. For example, the agent may query the forwarding engines to determine their make and/or model numbers. In another example, the agent may access a configuration file to determine the type of the forwarding engines. At block 410, the agent may identify the driver (or multiple drivers) that may be used to access, manage, communicate with, and/or perform operations on the processing device. For example, the agent may access a table that correlates different types of forwarding engines with different drivers.

At block 415, the agent may receive a request for a forwarding engine to perform an operation. For example, the agent may receive a request to access a forwarding engine and read the value of a configuration setting used by the forwarding engine. The request may be received by an agent of a first container, as discussed above. The request may originate from a library of a second container, as discussed above. At block 420, the agent may provide the request to an operating system of the first container. As discussed above, the operation system may include various drivers that are used to access the forwarding engines. The operating system may perform the requested operation using the driver identified in block 410. In some embodiments, blocks 405 and 410 may be performed after blocks 415 and/or 420. For example, after receiving the request for the forwarding engine to perform an operation, the agent may identify the type of forwarding engines and may identify a driver for the forwarding engines.

At block 430, the agent may determine if a result of the operation should be provided to the library and/or second container. For example, the agent may analyze the operation that was requested and determine whether the operation should return a result (e.g., return a value of a configuration parameter, return a value indicating success/failure, etc.). If result should be provided to the library and/or second container, the method 400 may transmit a message indicating the result, to the library and/or second container at block 435.

As discussed above, specific drivers or libraries are used to access, communicate with, and/or manage processing device. The primary host OS of the network device may not include the drivers and/or libraries. This results in additional work and time on part of the user to manage the different drivers that may be used by different types of processing devices. For example, if new processing devices are added to network device, new libraries or drivers should be added to allow control plane to access, communicate with, and/or manage the new processing devices. By using a separate, standalone or complete operation system, the network device may use the drivers and/or libraries included in the standalone OS to access, communicate with, manage, and/or perform operations using many different types of processing devices in the data plane. This may simplify the task of managing all of the different types of drivers and/or libraries, which was previously performed by the user. In addition, this allows simpler function calls, APIs, procedures, etc., to be used, rather than including a driver for a particular type of processing device. Furthermore, as the standalone OS is updated (e.g., new patches or releases are provided), the standalone OS may obtain new drivers and/or libraries that may be used for new devices (e.g., new types of FEs).

FIG. 4B is a flow diagram of a method 450 of accessing one or more network stacks, in accordance with some embodiments. Method 450 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, method 450 may be performed by a network device (e.g., network device 200 and 300 illustrated in FIGS. 2 and 3), an agent (e.g., agent 254 illustrated in FIGS. 2 and 3), an OA (e.g., OS 251 illustrated in FIGS. 2 and 3), and/or a processing device (e.g., processing device 108 illustrated in FIGS. 2 and 3). It should be appreciated that the actions of method 450 in FIG. 4B can be performed in differing orders, groupings, or subsets than shown in FIG. 4B, for various purposes or user preferences. As discussed a network device may include two network namespaces. Each network namespace may include its own network stack. The first network stack in the first network namespace may a primary network stack used by the network device.

Method 450 begins at block 455 where the agent and/or OS determines whether a modification to the primary network stack. For example, if the modification to the network stack is to add a new interface (e.g., a kernel interface), the agent and/or OS may be allowed to make that modification to the primary network stack. The agent and/or OS may access a table, a configuration file, configuration settings, parameters, etc., to determine which modifications and/or types of modifications (or operations) are allowed on the primary network stack. If the modification is allowed, the agent and/or OS may modify and/or access the primary network stack at block 480. If the modification is not allowed, the agent and/or OS may modify and/or access a second network stack in the second namespace at block 465.

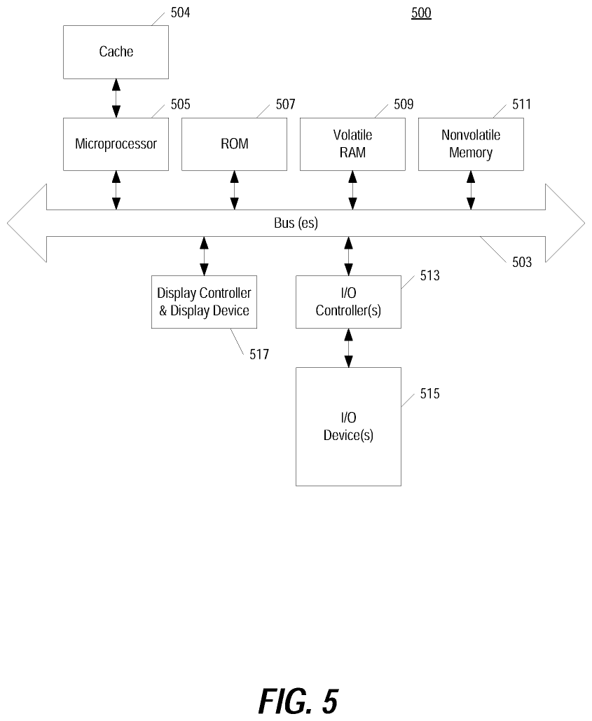

FIG. 5 shows an example computing device 500, in accordance with some embodiments. For example, the computing device 500 may be implemented including a network device 100 as shown in FIG. 1. Note that while FIG. 5 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 5, the computing device 500, which is a form of a data processing system, includes a bus 503 which is coupled to a microprocessor(s) 505 and a ROM (Read Only Memory) 507 and volatile RAM 509 and a non-volatile memory 511. The microprocessor 505 may retrieve the instructions from the memories 507, 509, 511 and execute the instructions to perform operations described above. The bus 503 interconnects these various components together and also interconnects these components 505, 507, 509, and 511 to a display controller and display device 517 and to peripheral devices such as input/output (I/O) devices which may be mice, keyboards, modems, network interfaces, printers and other devices which are well known in the art. In one embodiment, the computing device 500 includes a plurality of network interfaces of the same or different type (e.g., Ethernet copper interface, Ethernet fiber interfaces, wireless, and/or other types of network interfaces). In this embodiment, the computing device 500 can include a forwarding engine to forward network data received on one interface out another interface.

Typically, the input/output devices 515 are coupled to the system through input/output controllers 513. The volatile RAM (Random Access Memory) 509 is typically implemented as dynamic RAM (DRAM), which requires power continually in order to refresh or maintain the data in the memory.

The mass storage 511 is typically a magnetic hard drive or a magnetic optical drive or an optical drive or a DVD ROM/RAM or a flash memory or other types of memory systems, which maintains data (e.g., large amounts of data) even after power is removed from the system. Typically, the mass storage 511 will also be a random access memory although this is not required. While FIG. 5 shows that the mass storage 511 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 503 may include one or more buses connected to each other through various bridges, controllers and/or adapters as is well known in the art.

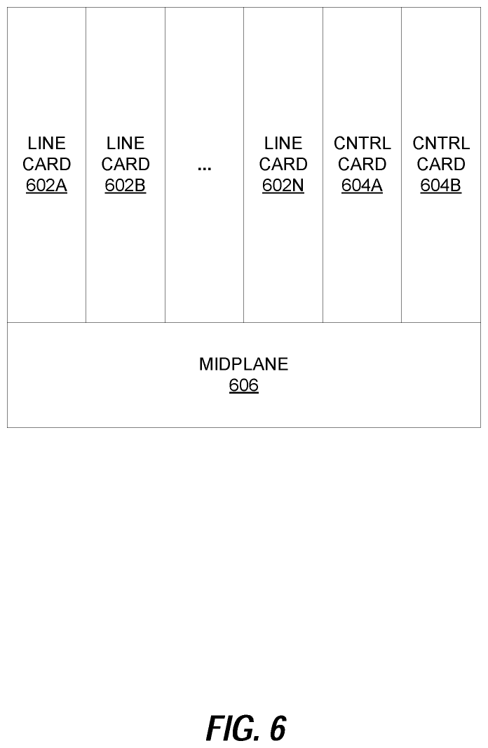

FIG. 6 is a block diagram of one embodiment of exemplary network device 600, in accordance with some embodiments. In FIG. 6, the midplane 606 couples to the line cards 602A-N and controller cards 604A-B. The midplane 606 may also be referred to as a fabric. While in one embodiment, the controller cards 604A-B control the processing of the traffic by the line cards 602A-N, in alternate embodiments, the controller cards 604A-B, perform the same and/or different functions (e.g., updating a software image on the network device, etc.). In one embodiment, the line cards 602A-N process and forward traffic according to the network policies received from the controller cards 604A-B. In one embodiment, the controller cards 604A-B may include containers, operating systems, and/or agents, as discussed above. It should be understood that the architecture of network device 600 illustrated in FIG. 6 is exemplary, and different combinations of cards may be used in other embodiments.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “process virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein. It should be appreciated that descriptions of direction and orientation are for convenience of interpretation, and the apparatus is not limited as to orientation with respect to gravity. In other words, the apparatus could be mounted upside down, right side up, diagonally, vertically, horizontally, etc., and the descriptions of direction and orientation are relative to portions of the apparatus itself, and not absolute.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two blocks in a figure shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
receiving, by an agent of a first container of a network device from a second container of the network device, a request for a forwarding engine of the network device to perform an operation, wherein:
the first container and the second container are located on a control plane of the network device;
the first container comprises a set of drivers to support multiple types of forwarding engines; and
the first container further comprises an operating system;
providing the request to the operating system, wherein the operating system uses a first driver of the set of drivers to communicate with the forwarding engine;
performing the operation requested by the second container; and
providing a result of the operation to the second container in response to determining that the result should be provided to the second container.

2. The method of claim 1, wherein performing the operation comprises:
translating the request to a format that is used by a process of the operating system; and
providing the translated request to the process of the operating system.

3. The method of claim 1, further comprising:
determining, by the first container, that the forwarding engine has detected an event; and
transmitting, by the first container to the second container, a message indicating that the event was detected.

4. The method of claim 3, wherein determining that the forwarding engine has detected the event comprises one or more of:
receiving, by the first container, a second message from the forwarding engine; and
detecting, by the first container, an interrupt from the forwarding engine.

5. The method of claim 1, further comprising:
identifying a type of the forwarding engine; and
identifying the first driver from the set of drivers based on the type of the forwarding engine.

6. The method of claim 1, wherein:
the first container is associated with a first network namespace; and
the second container is associated a second network namespace that is separate from the first network namespace.

7. The method of claim 6, wherein:
modifications to the first network stack do not affect a second network stack of the second network namespace.

8. The method of claim 7, wherein the first container is allowed to create a kernel interface in the second network stack.

9. The method of claim 1, wherein the forwarding engine is located on a data plane of the network device.

10. The method of claim 1, wherein the request for the forwarding engine of the network device to perform the operation is received from a library of the second container.

11. A network device, comprising:
a memory configured to store a first container and a second container; and
a processing device coupled to the memory, the processing device to:
receive, by an agent of the first container from the second container, a request for a forwarding engine of the network device to perform an operation, wherein:
the first container and the second container are located on a control plane of the network device;
the first container comprises a set of drivers to support multiple types of forwarding engines; and
the first container further comprises an operating system;
provide the request to the operating system, wherein the operating system uses a first driver of the set of drivers to communicate with the forwarding engine;
perform the operation requested by the second container; and
provide a result of the operation to the second container in response to determining that the result should be provided to the second container.

12. The network device of claim 11, wherein performing the operation comprises:
translating the request to a format that is used by a process of the operating system; and
providing the translated request to the process of the operating system.

13. The network device of claim 11, wherein the processing device is further configured to:
determining, by the first container, that the forwarding engine has detected an event; and
transmitting, by the first container to the second container, a message indicating that the event was detected.

14. The network device of claim 11, wherein the processing device is further configured to:
identifying a type of the forwarding engine; and
identifying the first driver from the set of drivers based on the type of the forwarding engine.

15. The network device of claim 14, wherein:
the first container is associated with a first network namespace; and
the second container is associated a second network namespace that is separate from the first network namespace.

16. The network device of claim 15, wherein:
the first container is allowed to modify a first network stack of the first network namespace; and
modifications to the first network stack do not affect a second network stack of the second network namespace.

17. The network device of claim 16, wherein the first container is allowed to create network interfaces in the second network stack.

18. The network device of claim 11, wherein the forwarding engine is located on a data plane of the network device.

19. The network device of claim 11, wherein the request for the forwarding engine of the network device to perform the operation is received from a library of the second container.

20. A non-transitory machine-readable medium having executable instructions to cause one or more processing devices to perform a method comprising:
receiving, by an agent of a first container of a network device from a second container of the network device, a request for a forwarding engine of the network device to perform an operation, wherein:
the first container and the second container are located on a control plane of the network device;
the first container comprises a set of drivers to support multiple types of forwarding engines; and
the first container further comprises an operating system;
providing the request to the operating system, wherein the operating system uses a first driver of the set of drivers to communicate with the forwarding engine;
performing the operation requested by the second container; and
providing a result of the operation to the second container in response to determining that the result should be provided to the second container.
